(19) United States
(12) Patent Application Publication
(10) Pub. No.: US 2013/0093885 A1
(43) Pub. Date: Apr. 18, 2013

(54) Aerial Imaging Array

(71) Applicant: Matthew Paul Mellor, Cumbria (GB)

(72) Inventor: Matthew Paul Mellor, Cumbria (GB)

(21) Appl. No.: 13/411,190

(22) Filed: Mar. 2, 2012

(30) Foreign Application Priority Data
Oct. 12, 2011 (GB) 1117667.4

(51) Int. Cl. H04N 7/18

(52) U.S. Cl. 348/145; 348/E07.085

(57) ABSTRACT

An aerial imaging array including at least two imaging devices provided on a mount attachable to an aircraft, such that the imaging devices view downwards. Each imaging device has a field of view, and the imaging devices are arranged such that there is a gap between adjacent fields of view. Each imaging device has an image frame, and each image frame has a vertical centerline and a transverse centerline. The imaging devices are posed within the mount such that the projections of the vertical centerlines onto a horizontal plane are substantially parallel. The gap between adjacent fields of view is at least a quarter of the width of the smaller of the adjacent fields of view, and the viewing directions of imaging devices providing adjacent fields of view are less than 20 degrees apart.

### BACKGROUND OF THE INVENTION

1. Field of the Invention

The present invention relates to an imaging array for aerial surveying, for use for example, but not exclusively, in the field of offshore environmental surveying.

2. Description of the Related Art

In the field of offshore environmental surveying, it is often necessary to carry out surveys of large areas of open sea in a short period of time. The only feasible way to achieve this is to use an aircraft to deploy some means of implementing an environmental survey. In the past, such surveys have often utilised specially trained human observers, who identify and count observed creatures, such as sea birds and marine mammals. More recently these techniques have been replaced by technologies based on digital image capture.

Digital imaging survey technologies have many intrinsic advantages over visual observers: the surveys are repeatable and auditable; the aircraft can fly higher, increasing safety and enabling surveys over man-made constructions such as wind-farms. One feature of digital methods that can sometimes be a disadvantage is the binary cut-off between those areas that are observed (in-frame) and those that are not. This has an impact on detection rate and therefore the statistical analysis of tightly grouped objects such as some sea ducks, or pods of marine mammals. Visual surveys are able to pick out these larger groups at some distance and hence achieve better sensitivity.

### SUMMARY OF THE INVENTION

The present invention provides an aerial imaging array comprising at least two imaging devices provided on a mount, attachable to an aircraft such that the imaging devices view downwards,

wherein each imaging device has a field of view, and the imaging devices are arranged such that there is a gap between adjacent fields of view;

wherein each imaging device has an image frame and each image frame has a vertical centerline and a transverse centerline, and the imaging devices are posed within the mount such that the projections of the vertical centerlines onto a horizontal plane are substantially parallel;

wherein the gap between adjacent fields of view is at least a quarter of the width of the smaller of the adjacent fields of view; and

wherein the viewing directions of imaging devices providing adjacent fields of view are less than 20 degrees apart.

Providing non-imaged gaps between adjacent fields of view achieves the effect of spreading survey effort over a wider area, and is statistically equivalent to replacing 100% detection of animals in a narrow band with partial detection of animals in a wider band. In this sense it is a closer approximation to the visual survey techniques, and inherits some of their statistical robustness properties. In particular, the probability of detecting large, densely packed groups of animals is significantly increased.

### BRIEF DESCRIPTION OF THE DRAWINGS

Embodiments of the invention will now be described, with reference to the accompanying drawings, in which:

FIG. 1 is a plan view of an imaging array according to an embodiment of the invention;

FIG. 2 is a side view of an imaging array according to an embodiment of the invention;

FIGS. 3 and 4 are, respectively, a plan view and a side view illustrating schematically the fields of view of the imaging array when mounted on a flying aircraft;

FIG. 5 is a perspective view of an imaging array according to an embodiment of the invention; and

FIG. 6 is a rear view of an imaging array according to an embodiment of the invention.

### DETAILED DESCRIPTION OF THE PREFERRED EMBODIMENTS

Embodiments of the invention comprise an array of two or more imaging devices. In the preferred embodiment shown in the figures there are four imaging devices 10.

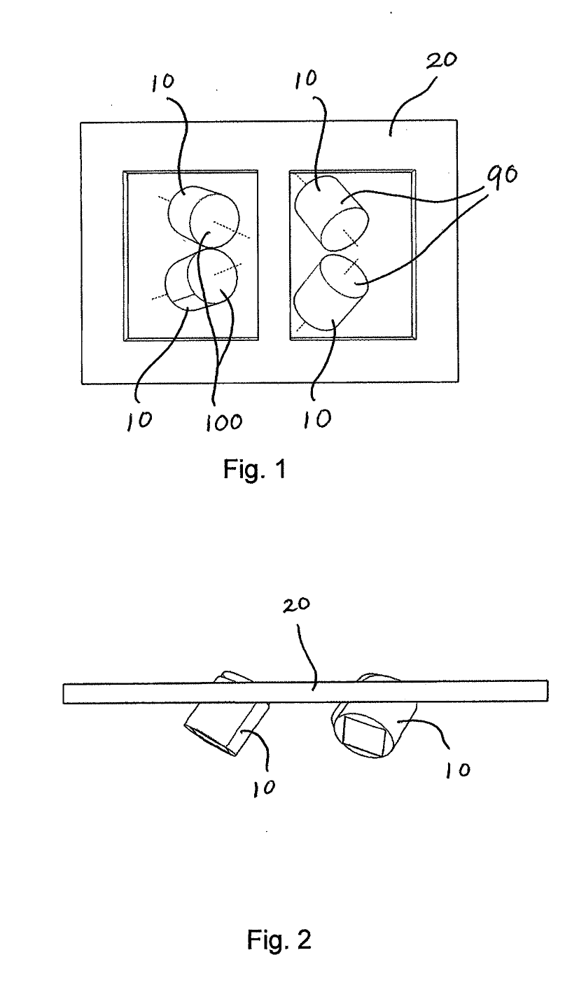

As shown in FIGS. 1 and 2, the imaging devices 10 are arranged in a mount 20.

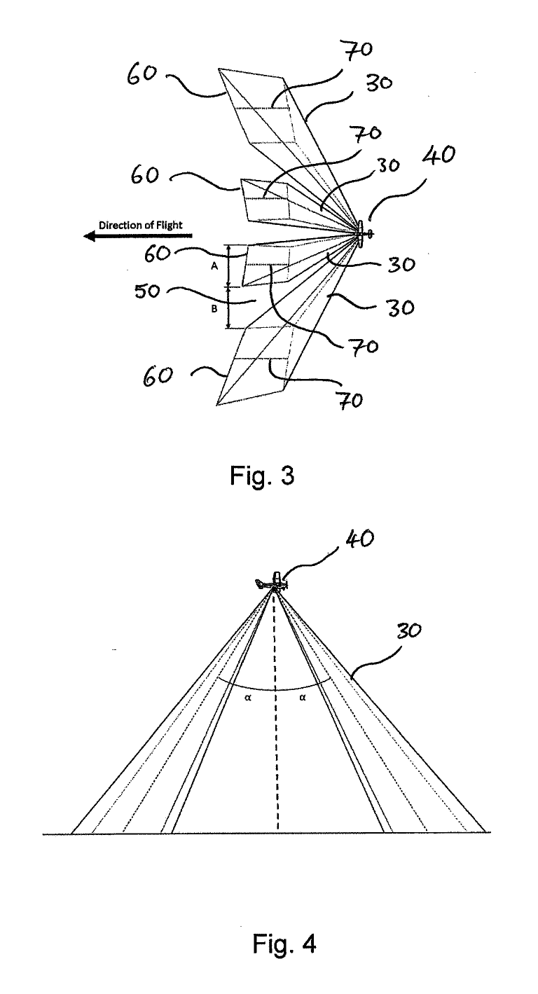

FIGS. 3 and 4 illustrate the fields of view 30 of the imaging devices when the mount 20 is arranged such that the imaging devices 10 look downward from an aircraft 40. Each field of view 30 is a rectangular-section cone. The imaging devices are arranged such that there is an un-imaged gap 50 between the adjacent fields of view 30. In this context, ‘adjacent’ refers to the nearest neighbouring field of view, though the fields of view are clearly not contiguous because there is a gap therebetween. In other words, the fields of view do not overlap.

In the preferred embodiment, each imaging device has a sensor at an image plane, at which the image is detected as a rectangular (or square) image frame. Each image frame has a transverse centerline and a vertical centerline, each centerline dividing the image frame into halves. In FIG. 3, the projection of the image frame of each imaging device onto a horizontal surface (such as the ground or sea) beneath the aircraft is shown by the quadrilaterals 60. The distortion of the quadrilaterals 60 is exaggerated in FIG. 3; in practice they are all approximately rectangular and of substantially the same size. The projections of the respective ‘vertical’ centerlines are shown by the dotted lines 70. The imaging devices 10 are positioned within the mount 20 such that the projections of the vertical centerlines 70 are parallel to each other. In this context, the so-called ‘vertical’ centrelines are those running closest to the direction of flight of the aircraft.

In a preferred embodiment, each imaging device is orientated about its optical axis such that the projection of each vertical centerline 70 is parallel to the direction of flight of the aircraft, i.e. parallel to the longitudinal axis of the fuselage of the aircraft 40. In this way, objects in the center of the image frame appear to travel vertically through the frame as the aircraft flies forwards.

Preferably the imaging devices 10 are adapted, for example using appropriate optical adjustment, such that projections of the transverse centerlines (not shown) of each imaging device have the same length as each other on the ground or sea being surveyed. This ensures that the width of the strip observed and the probability of species classification are consistent across imaging devices, enabling imaging devices to be treated a statistically equivalent. This enables the individual imaging devices to be treated as statistical replicates under certain circumstances, yielding data of better statistical quality, and avoids introducing statistical bias in the event that data from one camera should be lost.

In the illustrated embodiment of the invention, the imaging devices 10 are positioned in the mount 20 such that they do not look directly downwards, but at a forward or backward looking angle α, as shown in FIG. 4. In this way, the images represent a partially side-on view of the animals rather than a top down view; this makes many creatures (animals/birds) easier to recognise.

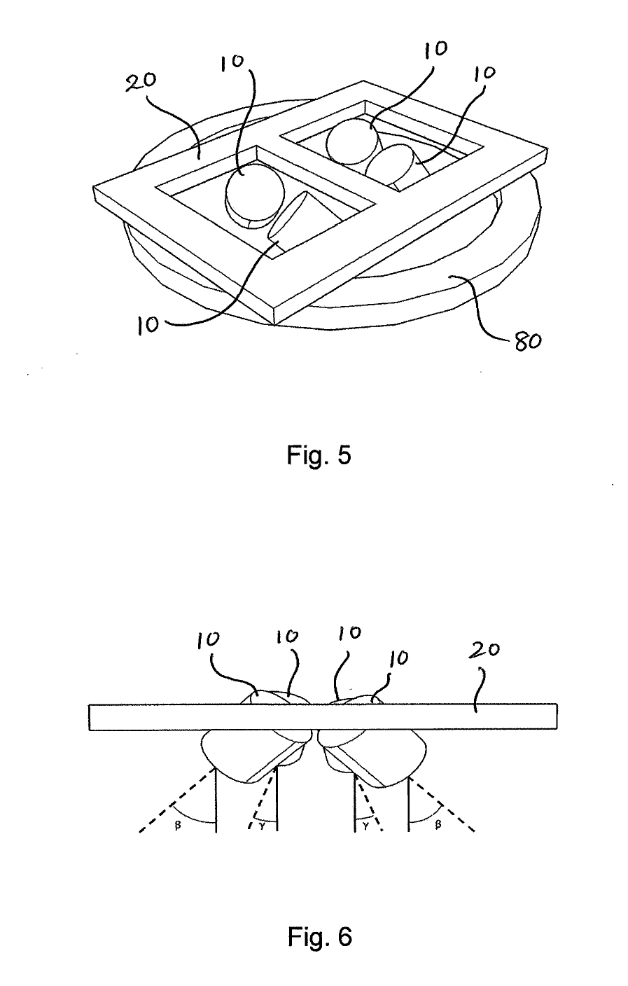

Preferably, the mount 20 is provided with a rotation facility, such as a ‘lazy-susan’ bearing 80, shown in FIG. 5, that enables the imaging devices 10 to be pointed consistently in the same direction (with respect to the ground) throughout a survey. For example, the imaging devices can point forward when the aircraft is flying in a first direction; the aircraft then turns through 180 degrees to make a pass flying in the opposite direction, but the mount 20 is also rotated through 180 degrees so that the imaging devices point backwards relative to the aircraft, but still in the same direction relative to the ground as when flying in the first direction.

In a preferred embodiment, the imaging devices are digital video cameras. Use of such cameras can enable the wing motion of flying birds to be observed.

In one embodiment of the imaging array, four digital video cameras with identical sensors and lens arrangements form the imaging array. The camera sensors each have a width of 2500 pixels, such that the image width is 50 m if each pixel images a width of 2 cm on the ground. The cameras are arranged in a mount positioned above a hole in the fuselage of a light aircraft 40. The hole is sufficiently large that the cameras have an unobstructed view. The cameras and lenses are selected such that the image width on the ground when looking forwards is between 10 m and 100 m, preferably 50 m, when the aircraft altitude is 600 m. As indicated in FIG. 1, the cameras are arranged in two pairs 90, 100, one in front of the other. The left and right cameras of one pair of cameras 90 are tilted to the left and right respectively by an angle β, shown in FIG. 6. In this context, tilting the camera refers, of course, to orientating the viewing direction of the camera in a particular direction (the viewing direction being the direction of the center of the field of view). The angle β is preferably at least 10 degrees and not more than 20 degrees, for example around 15 degrees. The cameras of the other pair 100 are tilted by an angle γ, where γ is less than β, as shown in FIG. 6. In a preferred example, the angle α is between one quarter and one half of the angle β, for example one third of β, or approximately 5 degrees, such that the gaps between the fields of view of all adjacent cameras are approximately equal. In a preferred embodiment, the viewing directions of imaging devices providing adjacent fields of view are less than 20 degrees apart. In this specific example the viewing directions of imaging devices providing adjacent fields of view are 10 degrees apart i.e. −15 degrees, −5 degrees, +5 degrees and +15 degrees.

According to this embodiment, the cameras are tilted forwards by an angle α between 10 and 45 degrees, preferably 30 degrees. Each camera is orientated such that the projections of their centerlines 70 on the ground are parallel. The cameras have fields of view in which the distance on the ground between the projections of the centerlines is significantly greater than the image width A. Referring to FIG. 3, the gap B between adjacent fields of view is at least a quarter the width of one of the fields of view, preferably at least half, and the gap B can be approximately the same as the width A, or greater.

For offshore applications, the angle α should be selected such that reflected light from the sun can be avoided at noon. The angle α may also be selected to optimise the recognition of animals in which profile is a particularly important feature, e.g. birds distinctively with long necks or legs.

What is claimed is:

1. An aerial imaging array comprising at least two imaging devices provided on a mount, attachable to an aircraft such that the imaging devices view downwards,
wherein each imaging device has a field of view, and the imaging devices are arranged such that there is a gap between adjacent fields of view;
wherein each imaging device has an image frame and each image frame has a vertical centerline and a transverse centerline, and the imaging devices are posed within the mount such that the projections of the vertical centerlines onto a horizontal plane are substantially parallel;
wherein the gap between adjacent fields of view is at least a quarter of the width of the smaller of the adjacent fields of view; and
wherein the viewing directions of imaging devices providing adjacent fields of view are less than 20 degrees apart.

2. The imaging array according to claim 1, wherein said projection of each vertical centerline is substantially parallel to the direction of flight of the aircraft.

3. The imaging array according to claim 1, wherein the imaging devices are configured such that the projections of the transverse centerlines onto a horizontal plane are substantially the same length as each other.

4. The imaging array according to claim 1, wherein the viewing direction of each imaging device is tilted forward or backward by an angle of at least 10 degrees from the vertical.

5. The imaging array according to claim 1, wherein the viewing direction of each imaging device is tilted forward or backward by an angle of not more than 45 degrees from the vertical.

6. The imaging array according to claim 1, comprising a first pair of imaging devices and a second pair of imaging devices, wherein the viewing directions of the imaging devices of the first pair are tilted left and right respectively by an angle β in the range of from 10 to 20 degrees, and the viewing directions of the imaging devices of the second pair are tilted left and right respectively by an angle γ that is less than β.

7. The imaging array according to claim 6, wherein the angle γ is between one quarter and one half of the angle β.

8. The imaging array according to claim 1 comprising four imaging devices.

9. The imaging array according to claim 1, wherein the gap between adjacent fields of view is at least half the width of the smaller of the adjacent fields of view.

10. The imaging array according to claim 1, wherein the mount comprises a rotatable frame to which the imaging devices are attached to enable the imaging devices to be rotated collectively with respect to the aircraft.

11. The imaging array according to claim 1, wherein each imaging device is a digital video camera.
